(19) United States
(12) Patent Application Publication
(10) Pub. No.: US 2019/0001819 A1
(43) Pub. Date: Jan. 3, 2019

(54) WAGON WITH AUTONOMOUS EMERGENCY POWER SUPPLY

(71) Applicant: DUECKER FOERDERTECHNIK GMBH, Langenfeld (DE)

(72) Inventor: Roland STEHR, Langenfeld (DE)

(21) Appl. No.: 15/576,741

(22) PCT Filed: Jun. 29, 2016
(86) PCT No.: PCT/EP2016/065168

§ 371 Date: Jan. 22, 2018

(30) Foreign Application Priority Data
Jun. 29, 2016 (DE) 10 2015 212 054.6

(51) Int. Cl. B60L 3/00; B60L 11/12; B60L 11/18; B60L 11/00; B60L 5/38

(52) U.S. Cl. CPC B60L 3/0038; B60L 11/12; B60L 11/1801; B60L 11/005; B60L 11/1816; B60L 7/00; B60L 3/0015; B60L 5/38; B60L 2200/26; B60L 2260/26; B60L 11/1822

(57) ABSTRACT

A conveying car comprises at least one support frame in which at least one driven conveying element is arranged, and a current collector for energizing drive means for driving the at least one conveying element and driving the conveying car; said conveying car is characterized in that same has its own power supply that is independent of the central power supply used for normal operation of the conveying car.

The invention relates to a mobile vehicle, particularly a wagon, having at least one support frame carrying at least one drive element and a current collector for energizing drive means for powering the at least one drive element and moving the wagon itself, according to the features of claim 1.

A wagon of this generic type is known from DE 10 2012 201 641 (shown in FIGS. 5 to 7 of that document).

This wagon has a drive that acts on drive means. The wagon itself has no power supply for the drive means; instead, the power is fed in from the outside.

In a known embodiment, the wagon runs with wheels in tracks that are embedded in the surface of a floor, such as that of a factory, for example. While the wagon is in motion, the drive means of the wagon are energized via appropriately designed current collectors from a central power supply. That is, the wagon is constantly connected to the central power supply via the current collectors.

In general, the power supply constantly supplies power and that this supplied power is also constantly transferred to the wagon for its operation.

However, there are exceptional situations, particularly emergency situations, in which the wagon is not constantly energized. This is particularly the case if the wagon drives through a fire safety wall with an appropriate opening, in which case this opening must be closed by a fire door in the event of a fire. In order to enable this door, for example a sliding door, to be closed in the event of a fire, it is necessary to fold away the power rail via which the wagon is connected with its current collector for the purpose of energy transfer, since it is located above the floor surface. However, if the wagon happens to be located at that precise moment where the power rail is folded away and the flow of current is thus interrupted in the area of the opening that is to be closed with the fire door, this closing procedure cannot be carried out, since the path of the fire door is obstructed by the wagon. This is a situation that must be prevented without fail.

Another exceptional situation occurs when the power supply is interrupted as a result of a technical defect, for example, while the wagon is traveling and a person or other obstacle is located directly in the travel path of the wagon right at that moment. Due to the mass inertia of the wagon (either by itself or even with a load), it does not come to a standstill right away when the power has failed. Such wagons therefore have not only a mechanical brake but also an electromechanical brake; however, such a brake requires a power supply. But if the power supply has failed, the electromechanical brake cannot be actuated, so that a safety-critical emergency arises here as well when the power supply fails.

The two emergency situations named above are intended only as examples and are not limitative.

It is therefore the object of the invention to provide a wagon as well as a method for operating such a wagon with which at least the described drawbacks are avoided.

This object is achieved, for one, in that the wagon has its own power source that is independent of the actual central power supply for the normal operation of the wagon. This separate power source is arranged in, against, or on the wagon. This separate power supply of the wagon ensures, for example, that the drive means for displacing the wagon can be operated for its locomotion, and optionally that of the drive elements as well, until the wagon has been moved out of the hazard area. In that case, the hazard area, particularly the distance to be traveled therein, is substantially shorter than the usual travel distances of the wagon during normal operation. The travel distance that must be ensured with the separate power supply of the wagon is at least one length of the wagon (when seen in the direction of travel) in order to ensure with certainty that the wagon can be driven out of the path of a fire door.

Alternatively or in addition, the independent power supply is dimensioned such that power can be supplied for at least one emergency braking operation with the aid of the electromechanical brake of the wagon.

For moving and/or emergency braking of the wagon, appropriate sensors and actuators as well as an algorithm are present that identify whether the wagon should be moved further and out of the hazard area or whether emergency braking is required.

The independent power supply of the wagon, which is not designed for the normal operation of the wagon, is a rechargeable battery, at least one capacitor (or an interconnection of a plurality of rechargeable batteries and/or capacitors) or the like. At the same time, the energy density of the stored energy is great enough that the travel distance out of the hazard area or the emergency braking operation is covered.

The use of capacitors to store energy is particularly advantageous because they have very high energy densities (thereby saving installation space and weight), can be operated in a wear-free manner over the service life of the wagon, and are easily exchangeable. Moreover, for wear-free energy storage, capacitors enable continuous charging cycles, so the power supply for responding to emergency situations is ensured at all times during the operation of the vehicle by a suitable automatic charging system.

Furthermore, in order to achieve its object, the invention proposes a method for operating a wagon in which sensors are present on the wagon and/or outside of same which identify an emergency situation and activate appropriate means for responding to the emergency situation. This means is a switch point in the power rail, for example, that is folded away not only in order to interrupt the central power supply for the wagon but also to make it possible to travel through a fire door. This means is also a switching means that switches to the independent power supply to its drive means when the central power supply from the outside has failed. This means is also one with which the type of emergency situation is identified and, on that basis, triggers continued travel or an emergency braking operation.

The energy stored in the independent power supply is sufficient in any case to ensure that not only the empty wagon, but also the wagon with its maximum load can still be moved reliably over a predefined distance or brought to a standstill within a predefined distance when the power supply that is fed in from the outside has failed.

The independent power supply of the wagon is either installed permanently therein or exchangeable, in which case appropriate plug connectors are present between exchangeable power supply and wagon. The same applies to the mechanical support of the exchangeable power supply in the wagon, by means of which the simple insertion and equally simple removal of the independent power supply is ensured and complex installation and removal work is avoided.

The invention is based, for example, on a wagon such as those known from DE 10 2012 201 641 (shown in FIGS. 5 to 7 of that document), although it is not limited to the specific design of this wagon.

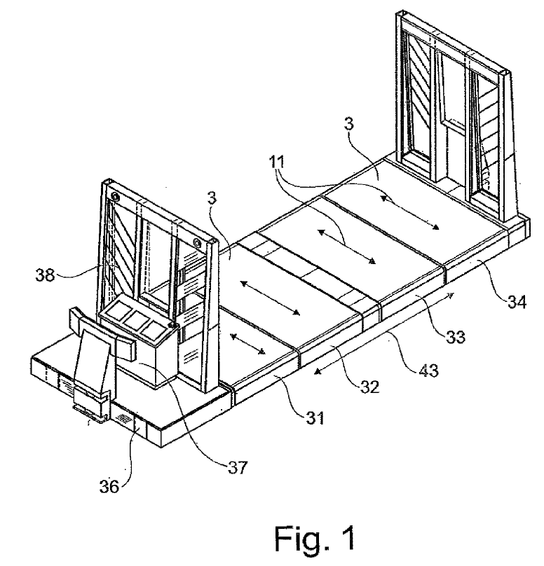

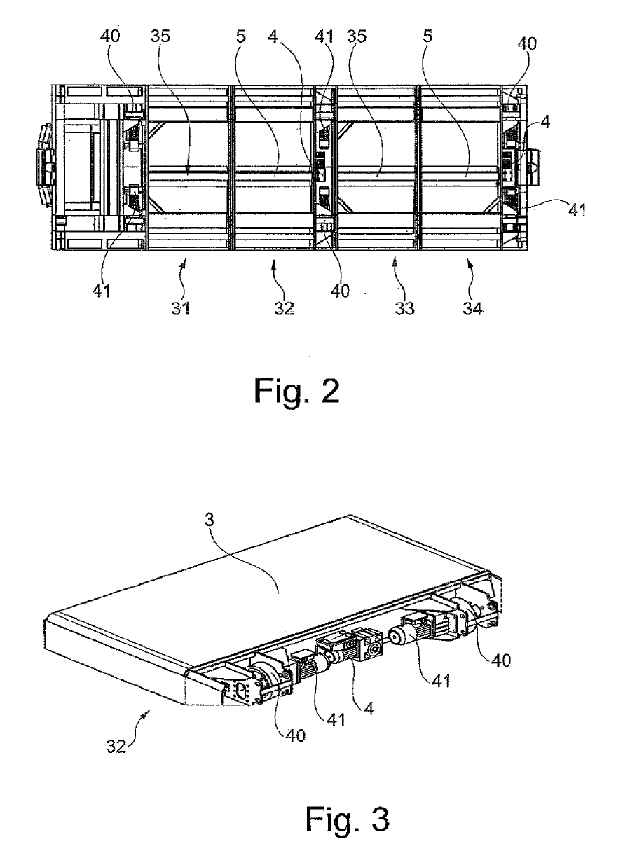

Insofar as illustrated in detail, FIGS. 1 to 3 show a vehicle in which mechanically interconnected support frames form a wagon. The wagon contains a number of mechanically and detachably interconnected support frames 31, 32, 33, 34, of which the frames 32 and 34 that are embodied as main frames contain the drive motors 4 for the drive elements 3. In the embodiment, four support frames 31 to 34 are present. The drive elements 3 are preferably circumferential link conveyors that can be driven by drive shafts 5, 35 in the directions of the double arrow 11 and form a flat conveying surface. As can be seen from the view from below in FIG. 2, two conveying devices are arranged next to one another, and each consists of a main frame 32, 34 and an additional support frame 31, 33 that is connected on the long side to the respective main frame 32, 34. In addition, the two inner frames 32, 33 are interconnected on the other long side, so that a support structure is created in which a respective main frame 32, 34 is connected to an additional support frame 31, 33. In addition, the support frame 31 is connected on one side to an additional support frame 36, on which control consoles 37 and retaining and protective elements 38 are fastened. As can be seen, the control console is box-shaped, so that the at least one power supply (not shown) of the wagon for emergency situations (if the external power feed via current collectors (which are present but not shown) to the wagon is interrupted from the outside) can be accommodated permanently or exchangeably within the box-shaped housing of the control console 37, for example.

Each of the main frames 32, 34 and the frames 36 has a drive wheel 40 on each long side that is driven by a traction drive 41. The wagon, which consists of four conveying devices 31 to 34, can thus be moved transversely to the direction of conveyance 11 of the drive elements 3 in the directions of the double arrow 43. The goods to be transported can thus be transported in two mutually perpendicular directions.

Preferably, all of the support frames 31 to 34 are embodied as self-supporting frames in which all functional frame parts also contribute to the stability. Preferably, the frame parts are provided with elements that enable a plug connection between neighboring frame parts. Neighboring frame parts can thus be easily positioned relative to one another and interconnected via a plug connection. Elements for such plug connections can be tongues or bolts that are fitted in exactly fitting holes of the other frame part. The same applies to electrical plug connections and cabling in the event that the separate power supply of the wagon is only present against, in, or on one of the support frames 31 to 34 and the drive means of the other support frames must be supplied with power in the emergency situation. Alternatively, the wagon can also have only one single support frame.

1. A wagon comprising:
at least one support frame; at least one drive element on the support frame;
a current collector on the support frame;
drive means for driving at least one drive element and thereby moving the wagon itself; and
a separate power source on the support frame and independent of the central power source for the normal operation of the wagon.

2. The wagon defined in claim 1, wherein the separate power source is a rechargeable battery.

3. The wagon defined in claim 1, wherein the separate power source is at least one capacitor.

4. The wagon defined in claim 1, 2, wherein the separate power source of the wagon is installed permanently therein.

5. The wagon defined in claim 1, wherein the separate power source of the wagon is arranged exchangeably therein.

6. A method for operating a wagon having at least one support frame carrying at least one drive element, as well as a current collector for energizing drive means for driving the at least one drive element and for displacing the wagon itself, the method comprising the step of:
providing the wagon with a separate power source that is designed so as to be independent of the central power source for the normal operation of the wagon and that sensors are present on the wagon and/or outside of same to identify an emergency situation and activate means for responding to the emergency situation.

7. The method defined in claim 6, wherein the means is a switching means that switches the separate power source of the wagon to its drive means when the central power source from the outside has failed.

8. The method defined in claim 6, wherein the means identifies the type of emergency situation and, on that basis, enacts continued travel of the wagon or an emergency braking operation.
